(19) United States
(12) Patent Application Publication
(10) Pub. No.: US 2006/0187836 A1
(43) Pub. Date: Aug. 24, 2006

(54) Communication device and method of prioritizing transference of time-critical data

(76) Inventors: Stefan Frey, Bern (CH); Thomas Siegrist, Zuerich (CH); Ramon Felder, Liebefeld (CH)

Correspondence Address: EDELL, SHAPIRO & FINNAN, LLC, 1901 RESEARCH BOULEVARD, SUITE 400, ROCKVILLE, MD, 20850, US

(21) Appl. No.: 11/060,594

(22) Filed: Feb. 18, 2005

(51) Int. Cl. H04J 1/16; H04L 12/26

(52) U.S. Cl. 370/235; 370/253

(57) ABSTRACT

A communication device according to the present invention enhances transfer of time-critical data between one or more LANs and a device (e.g., edge router, etc.) coupled to a backbone network. A virtual bottleneck in the form of a queue is introduced by the communication device at the customer premises or customer end of a backbone network access line where the network congestion or bottleneck resides. The virtual bottleneck delays and/or discards time insensitive traffic prior to time-critical or voice traffic being delayed in the edge router. This is accomplished by the virtual bottleneck queue including a storage capacity or length less than that of a queue utilized by the edge router. A traffic manager or scheduler controlling the virtual bottleneck dynamically adjusts the virtual bottleneck based on the bandwidth required for time-critical packets to ensure sufficient bandwidth is available for those packets.

### BACKGROUND OF THE INVENTION

1. Technical Field

The present invention pertains to devices for network communications. In particular, the present invention pertains to an access router (e.g., a router that transfers data between an end-user system or local network and an access line for a backbone network) that reduces the delay and packet loss of real-time down-steam traffic (e.g., time-critical packets transferred over the access line from the backbone network toward the end-user system). The access router may be employed in the event that the backbone network and corresponding edge router (e.g., a router that transfers data between the backbone network and access line) lack support for distinguished handling of certain data traffic.

2. Discussion of Related Art

Currently, a majority of large Internet Protocol (IP) networks (e.g. Internet, etc.) only support best effort packet forwarding, where all packets are treated equally without differentiation between time-critical IP packets (e.g., packetized telephony or Voice Over IP (VoIP)) and time insensitive data traffic (e.g., Web pages, mail, etc.). If an overload occurs within the network (e.g., at a congestion point or network bottleneck), time-critical packets have the same probability of being discarded as time insensitive data packets. The loss of time-critical packets (e.g., voice packets, etc.) leads to degradation in the received data stream (e.g., voice quality, etc.), whereas loss of time insensitive data traffic is accommodated by a retransmission of the discarded data with the user merely experiencing slower response time.

A conventional communications configuration or topology is illustrated in FIG. 1. Specifically, the configuration includes an end-user computer system 2, a backbone network or Internet 8, an access router 10, a voice terminal 12, a server system 14 and an edge router 20. End-user system 2 is preferably implemented by a conventional personal computer and is coupled to access router 10 via a Local Area Network (LAN) 4. The LAN may include a set of network nodes that are connected to an interconnecting network through a relatively narrow access link. Alternatively, individual devices may be directly connected to the access router without use of a LAN or other network. The access router may be further coupled to any quantity of conventional or other devices for transfer of information (e.g., personal computers with or without voice capability, voice terminals or telephones, etc.), while the LAN may similarly be further coupled to any quantity of conventional or other devices for transfer of information (e.g., personal computers with or without voice capability, voice terminals or telephones, etc.).

The access router transfers information between the LAN and an access line 6. The access line is coupled to backbone network 8 via edge router 20. The edge router is preferably implemented by a conventional routing device (e.g., router, gateway, etc.) and transfers information between the access line and backbone network. The access line is generally a relatively narrowband link between LAN 4 and backbone network 8, and is typically implemented by a broadband Internet access scheme (e.g., generally including a bandwidth less than approximately 2 Megabits per second (Mb/s), such as ADSL, xDSL, Cable, etc.). The backbone network is further coupled to server system 14 and voice terminal 12. The server system is typically in the form of a Web server and is preferably implemented by a conventional server computer system to transfer information with end-user system 2 (e.g., or other devices coupled to LAN 4 or access router 10) in a conventional manner. The voice terminal may be implemented by any conventional voice devices (e.g., telephone, personal computer with voice capability, etc.) and transfers information with end-user system 2 (e.g., or other devices coupled to LAN 4 or access router 10) via backbone network 8 in a conventional manner.

Access line 6 transfers time-critical (e.g., voice packets, etc.) and time insensitive (e.g., Web pages being downloaded to the LAN, etc.) data traffic. Since LAN 4 (e.g., employing a 10/100 Megabits per second (Mb/s) Ethernet connection) and backbone network 8 (e.g., Fibre, SDH, or ATM type networks) are faster or include greater bandwidth than access line 6 (e.g., generally including a bandwidth of less than approximately 2 Mb/s), the congestion point or bottleneck of the network configuration for time-critical and other data is typically subscriber access line 6. In order to accommodate traffic flow, packets received by the edge router when the access line is unavailable (e.g., at maximum capacity) may be stored by the edge router in a bottleneck queue 16 for later transmission. However, communications protocols (e.g., Transmission Control Protocol (TCP)) may fill and overflow the bottleneck queue to adapt to a connection bandwidth, thereby tending to discard packets overflowing from the queue. For example, TCP uses implicit feedback for the flow control mechanism, where the bandwidth is continuously increased until the maximum throughput is reached and packets are dropped (e.g., indicated by a lack of an acknowledgement by the destination).

Although queuing of packets is normal for TCP operation (and even vital for TCP bulk transfers), this is unacceptable for time-critical data (e.g., packetized telephony, etc.). Initially, the transmission delay introduced by the edge router storing packets within the bottleneck queue depends upon the down-stream bandwidth (e.g., bandwidth of the access line from the edge router toward the end-user system) and the size of the queue (e.g., and, hence, the infrastructure of the communication configuration). Typically, the transmission delays affect transfer of time-critical information (e.g., voice, etc.) sufficiently to enable users to notice degradation (e.g., in voice signals, etc.) in a two-way communication.

Loss or discarding of time-critical data packets (e.g., voice, etc.) should be minimized in order to maintain quality of the transmission stream (e.g., voice signals). However, TCP relies on packet losses to determine when a bottleneck link is at full capacity, thereby poorly accommodating time and loss sensitive data transfers. Although this problem may be solved at the edge router, the configurations required are extremely complex and unavailable from manufacturers. Typically, current edge routers offer only best effort packet forwarding that tends to discard time-critical packets and degrade quality of the data stream as described above.

### OBJECTS AND SUMMARY OF THE INVENTION

Accordingly, it is an object of the present invention to enhance the transfer of time-critical data over an access line between an end-user system and a backbone network.

It is another object of the present invention to enhance transfer of time-critical data over an access line by employing a virtual bottleneck to delay and/or discard time insensitive packets based on the bandwidth required for time-critical packets (e.g., voice calls, etc.) in order to ensure that sufficient bandwidth is available for transference of the time-critical packets.

Yet another object of the present invention is to indirectly control transference of time critical data over an access line by adjusting the transference rate of time insensitive data based on a measurement of time-critical data traffic.

Still another object of the present invention is to employ a virtual bottleneck for time insensitive data within an access router to enhance and prioritize transfer of time-critical data in the down-stream direction from a backbone network toward an end-user system.

The aforesaid objects may be achieved individually and/or in combination, and it is not intended that the present invention be construed as requiring two or more of the objects to be combined unless expressly required by the claims attached hereto.

According to the present invention, a communication device enhances transfer of time-critical data between one or more LANs and a device (e.g. gateway, router, etc.) coupled to a backbone network. The present invention is employed in a network topology without specific handling of traffic types at the point of congestion, and enhances the quality of selected time-critical data transfers at the cost of reduced throughput for remaining active transfers of other types of data (e.g., time insensitive data). A virtual bottleneck in the form of a queue is introduced by the communication device at the customer premises or customer end of the access link where the network congestion or bottleneck resides. The virtual bottleneck delays and/or discards time insensitive traffic prior to time-critical or voice traffic being delayed in the edge router. This is accomplished by the virtual bottleneck queue including a storage capacity or length less than that of the queue utilized by the edge router. The maximum number of packets queued by the virtual bottleneck is configured to prevent the window size of time insensitive traffic from increasing significantly. A smaller size of the virtual bottleneck queue leads to an increased number of dropped time insensitive packets, whereas a greater size of the virtual bottleneck queue enables more frequent bursts of packets (e.g., time-critical and time insensitive packets) to fill the edge router queue, thereby causing delay for the time-critical transfers.

The data rate of the virtual bottleneck is selected to include a safety margin to enable traffic bursts of time insensitive packets to traverse the access line without causing annoying delays or packet losses in the edge router. This data rate is automatically lowered based on the amount of time-critical traffic to maintain the safety margin at a sufficient level and to accommodate time insensitive traffic bursts. The efficiency of the present invention depends upon the amount of available bandwidth for the safety margin in the presence of time-critical traffic.

The present invention capitalizes on the property that most competing data transfers (e.g., time-critical and time insensitive data transfers) are flow controlled. For example, TCP uses implicit feedback for the flow control mechanism, where the bandwidth is continuously increased until the maximum throughput is reached and packets are dropped from the edge router queue (e.g., indicated by a lack of an acknowledgement by the destination). The present invention virtual bottleneck or queue enables delay and/or discarding of time insensitive packets within the access router prior to the access line attaining full capacity. A traffic manager or scheduler controlling the virtual bottleneck dynamically adjusts the virtual bottleneck based on the bandwidth required for time-critical packets (e.g., voice calls, etc.) to ensure sufficient bandwidth is available for those packets. Accordingly, the present invention may be utilized for any flow control scheme that relies on implicit congestion indications (e.g., delay or packet loss).

The present invention provides several advantages. For example, since the present invention does not rely on packet introspection, the present invention may be utilized for tunneled and/or encrypted (e.g., Virtual Private Network (VPN)) packets when the data stream utilizes a flow control scheme (e.g., TCP, UDP, etc.). Further, the virtual bottleneck employed by the present invention in the down-stream direction (e.g., toward the end-user system) does not hinder real-time traffic or control packets flowing in the upstream direction (e.g., toward the backbone network). Since the virtual bottleneck is employed only in the presence of active time-critical transmissions, time insensitive traffic is not queued or delayed in the absence of active voice calls and may attain maximum download speeds. Moreover, control packets (e.g., acknowledgement packets, etc.) associated with traffic flowing in the upstream direction (e.g., the direction opposite the virtual bottleneck) are not affected by the present invention. These packets bypass the bottleneck queue, but are accounted for by a stricter bandwidth limit for time insensitive traffic.

In addition, the present invention ensures voice quality in typical network load situations since the likelihood of the access line being flooded (e.g., multiple sources sending data at the same time) prior to the effect of the virtual bottleneck is remote. Further, the present invention improves jitter and packet losses for time-critical data traffic over a link employing a best-effort forwarding scheme by enforcing a stricter bandwidth and burst limit on time insensitive data traffic traversing that link in the same direction. The stricter bandwidth limit is enforced by storing packets in a virtual bottleneck queue that includes a lower data or bit rate and stores a limited number of packets. The bandwidth and burst limit applied to time insensitive traffic is configured in terms of a leaky bucket with an average bit rate and a burst tolerance measured as a number of packets.

The present invention is not limited to TCP traffic, but is effective with any type of traffic that utilizes a flow control scheme autonomously detecting available bandwidth based on congestion indicators in the form of delay and discarded packets.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 is a diagrammatic illustration of an exemplary communication network access configuration or topology.

FIG. 2 is a diagrammatic illustration of an exemplary communication network access configuration or topology employing an access router to enhance time-critical data transfers according to the present invention.

FIG. 3 is a flow diagram of the processing architecture of the access router of FIG. 2.

FIG. 4 is a block diagram of the link scheduler module of the access router processing architecture of FIG. 3 for prioritizing time-critical data transfers according to the present invention.

### DETAILED DESCRIPTION OF THE PREFERRED EMBODIMENTS

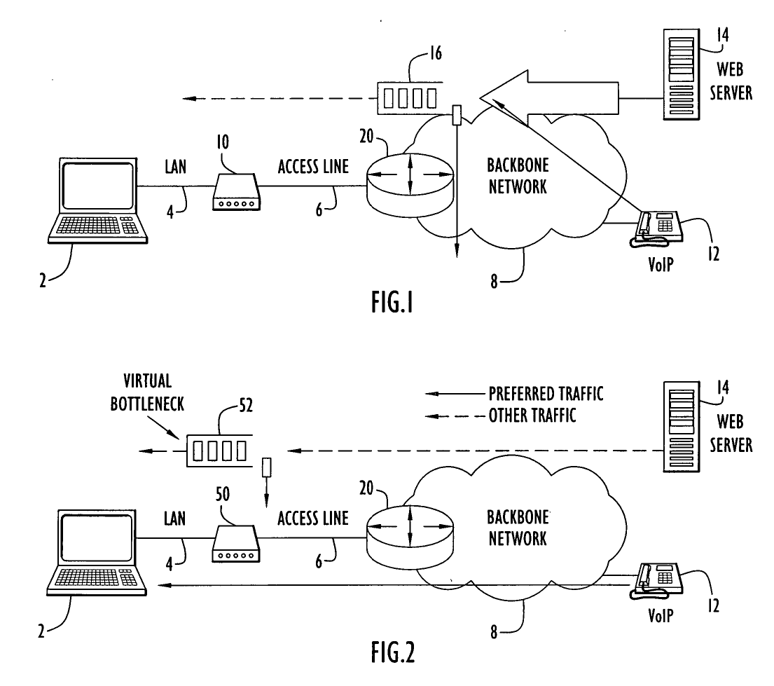

The present invention pertains to an access router (e.g., a router that transfers data between an end-user system or local network and an access line for a backbone network) that reduces the delay and packet loss of real-time down-steam traffic (e.g., time-critical packets transferred over the access line from the backbone network toward the end-user system). An exemplary communications configuration or topology employing an access router according to the present invention is illustrated in FIG. 2. Specifically, the configuration is substantially similar to the configuration described above and includes end-user computer system 2, Local Area Network (LAN) 4, access line 6, backbone network or Internet 8, voice terminal 12, server system 14 and edge router 20, each as described above. The configuration further includes an access router 50 that enhances transfer of time-critical data packets in accordance with the present invention as described below. End-user system 2 is preferably implemented by a conventional personal computer and is coupled to access router 50 via Local Area Network (LAN) 4. The LAN may include a set of network nodes that are connected to an interconnecting network through a relatively narrow access link. Alternatively, individual devices may be directly connected to the access router without use of a LAN or other network as described above. Access router 50 may be further coupled to any quantity of conventional or other devices for transfer of information (e.g., personal computer with or without voice capability, voice terminals or telephones, etc.), while the LAN may similarly be further coupled to any quantity of conventional or other devices for transfer of information (e.g., personal computers with or without voice capability, voice terminals or telephones, etc.).

The access router transfers information between the LAN and access line 6. The access line is coupled to backbone network 8 via edge router 20. The edge router is preferably implemented by a conventional routing device (e.g., router, gateway, etc.) and transfers information between the access line and backbone network as described above. The access line is generally a relatively narrowband link between LAN 4 and backbone network 8, and is typically implemented by a broadband Internet access scheme (e.g., generally including a bandwidth less than approximately 2 Megabits per second (Mb/s), such as ADSL, xDSL, Cable, etc.). The backbone network is further coupled to server system 14 and voice terminal 12. The server system is typically in the form of a Web server and is preferably implemented by a conventional server computer system to transfer information with end-user system 2 (e.g., or other devices coupled to LAN 4 or access router 50) in a conventional manner. The voice terminal may be implemented by any conventional voice devices (e.g., telephone, personal computer with voice capability, etc.) and transfers information with end-user system 2 (e.g., or other devices coupled to LAN 4 or access router 50) via backbone network 8 in a conventional manner.

Access line 6 transfers time-critical (e.g., voice packets, etc.) and time insensitive (e.g., Web pages being downloaded to the LAN, etc.) data traffic. Since LAN 4 (e.g., employing a 10/100 Megabits per second (Mb/s) Ethernet connection) and backbone network 8 (e.g., Fibre, Synchronous Digital Hierarchy (SDH), Asynchronous Transfer Mode (ATM), etc.) are faster or include greater bandwidth than access line 6 (e.g., generally including a bandwidth less than approximately 2 Mb/s), the congestion point or bottleneck of the network access configuration for time-critical and other data is typically subscriber access line 6. In order to accommodate traffic flow, packets received by the edge router when the access line is unavailable (e.g., at maximum capacity) may be stored by the edge router in bottleneck queue 16 (FIG. 1) for later transmission as described above. However, communications protocols (e.g., Transmission Control Protocol (TCP)) may fill and overflow the bottleneck queue to adapt to a connection bandwidth, thereby tending to discard packets overflowing from the queue as described above.

Although queuing of packets is normal for TCP operation (and even vital for TCP bulk transfers), this is unacceptable for time-critical data (e.g., packetized telephony, etc.) since the transmission delay introduced by the edge router storing packets within the bottleneck queue affects transfer of time-critical information (e.g., voice, etc.) sufficiently to enable users to notice degradation (e.g., in voice signals, etc.) in a two-way communication. Further, loss or discarding of time-critical data packets (e.g., voice, etc.), should be minimized in order to maintain quality of the transmission stream (e.g., voice signals). However, since TCP relies on packet losses to determine when a bottleneck link is at full capacity, time and loss sensitive data are usually discarded, thereby degrading quality in the transmitted time-critical data stream.

In order to enhance transfer of time-critical data, access router 50 employs a virtual bottleneck 52 to delay and/or discard time insensitive traffic prior to time-critical or voice traffic being delayed in the edge router. Initially, Quality of Service (QoS) with respect to networks generally refers to the capability of a network to provide a better service to selected network traffic. In the context of Voice Over IP (VoIP) or other time-critical data, the goal is to control handling of voice and time insensitive packets with minimal transmission delay for the voice packets. The present invention access router employs a link scheduler module to classify packets for special handling and to define the order in which packets of different classifications (e.g., voice or time-critical and time insensitive) are processed as described below.

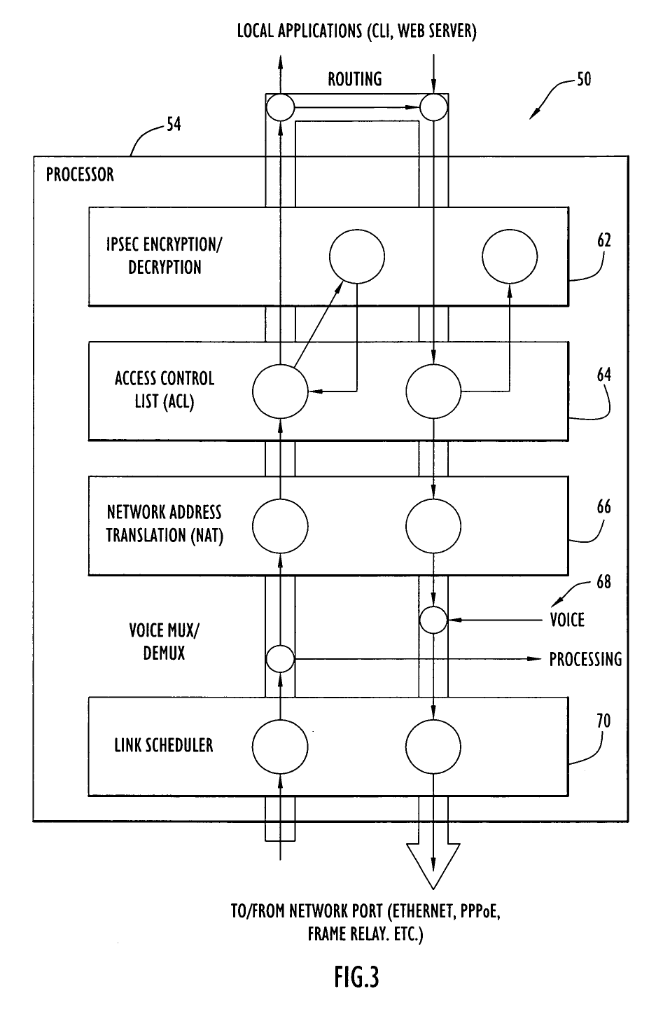

An exemplary architecture for access router 50 is illustrated in FIG. 3. Specifically, the access router includes an encryption/decryption module 62, an access control list module 64, a network translation module 66, a voice processing module 68 and a link scheduler module 70. Preferably, the access router includes a conventional microprocessor or controller 54 with the access router modules being implemented by software modules to enable the controller to perform the various access router functions. However, the access router modules may alternatively be implemented by hardware modules, software modules or any combination thereof. The access router modules typically enable performance of conventional router functions. However, a link scheduler module of the access router, or a combination of the link scheduler and access control list modules of the access router, are modified to enhance transfer of time-critical data in accordance with the present invention as described below.

Access router 50 transfers packets between the access line and LAN as described above, while enhancing transfer of time-critical data in the down-stream direction (e.g., from the backbone network toward the end-user system). Initially, a data packet may be received by the access router for processing in the upstream direction (e.g., from the end-user system toward the backbone network) from a network port of the LAN via various communication protocols (e.g., Ethernet, Point to Point Protocol Over Ethernet (PPPoE), Frame Relay, etc.). Link scheduler module 70 initially receives the incoming packet. Since the link scheduler module needs to distinguish between different types or classes of packets for special handling of time-critical packets in the down-stream direction (e.g., toward the LAN or end-user system), the link scheduler module may determine the packet type as time-critical or time insensitive and mark the packet with the packet type.

The packet classification may be indicated by a tag associated with or stored within the packet. The traffic tags are typically present within the access router; however, various protocol bits or fields (e.g., 802.1pq class-of-service, IP header type-of-service bits (TOS field), etc.) may be utilized to identify a specific packet type for other network nodes. Packets are classified as time-critical (e.g., voice, etc.) when a time-critical packet originates or is created by the access router, or when a packet corresponds to return traffic sent in response to the router originated time-critical packets and terminates at the access router. These conditions may be determined based on information within the packet (e.g., packet header, etc.). Packets may further be classified as time-critical based on user-configurable criteria. A packet may be classified by the link scheduler in the upstream and down-stream directions to enhance time-critical data transfer in the down-stream direction as described below.

Once a packet classification has been determined, the link scheduler module stores the packet in an appropriate queue based on the packet type and schedules the packet for transmission as described below. The link scheduler module transfers a packet to voice processing module 68 in accordance with various scheduling conditions as described below. The voice processing module receives a packet from the link scheduler module and processes any voice related information within the packet. Network translation module 66 receives the packet from the voice processing module and provides address conversion for the packet with respect to various networks (e.g., LAN, backbone network or Internet, etc.) coupled to the access router.

Access control list module 64 receives the packet from the network translation module and serves as a filter to block certain types of traffic. Further, the access control list module may determine classifications for the packet other than time-critical and time insensitive. Moreover, the access control list module may be modified in accordance with the present invention to classify a packet as time-critical or time insensitive for special processing by the link scheduler module as described above, where this traffic classification may be applied based on the module IP-header filtering capabilities. A packet may be classified as time-critical or time insensitive by the access control list module in the upstream and down-stream directions for special handling by the link scheduler module to enhance time-critical data transfer in the down-stream direction as described below.

Encryption/decryption module 62 receives the packet from access control list module 64 and applies the appropriate encryption or decryption for transmission by the access router toward the backbone network and Web server for processing (e.g., by Common Language Infrastructure (CLI) or Web Server applications, etc.).

With respect to the down-stream direction (e.g., from the backbone network toward the end-user system), a packet may be received over the access line by the access router from the backbone network or edge router, or a packet may be routed through the down-stream processing after being received and processed by the access router. In particular, encryption/decryption module 62 receives the down-stream packet and applies the appropriate encryption or decryption as described above. Access control list module 64 receives the packet from encryption/decryption module 62 and may filter and/or classify the packet as described above. Network translation module 66 receives the packet from the access control list module and provides address conversion for the packet as described above, while voice processing module 68 receives the packet from the network translation module to process any voice related information within the packet.

Link scheduler module 70 receives the packet from the voice processing module and determines the packet type (e.g., a time-critical or time insensitive data packet), stores the packet in the appropriate queue based on the packet type and schedules the packet for transmission as described below. The packet is transmitted from the access router to the network port of the LAN.

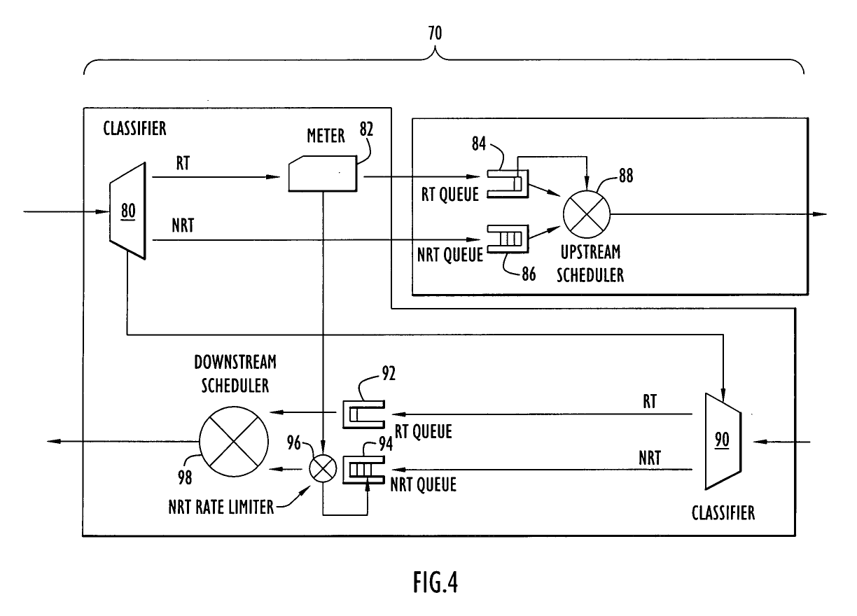

Access router 50 basically utilizes a virtual bottleneck within link scheduler module 70 to enhance time-critical data transfer as illustrated in FIG. 4. Initially, time-critical data packets are identified by the link scheduler module in order to provide those packets with increased priority over time insensitive packets. Specifically, the link scheduler module includes packet classifiers 80, 90, a bandwidth meter 82, queues 84, 92 for time-critical packets, queues 86, 94 for time insensitive packets, schedulers 88, 98 and a rate limiter 96. These components are preferably implemented by software modules residing on the access router processor as described above. However, the link scheduler module components may be implemented by software modules, hardware modules or any combination thereof.

A packet is initially received in the upstream direction (e.g., from the end-user system toward the backbone network) by the link scheduler module from the network port of the LAN as described above. Classifier 80 examines the packet to determine the packet classification as a time-critical or real-time packet (e.g., RT as viewed in FIG. 4) or as a time insensitive or non-real-time packet (e.g., NRT as viewed in FIG. 4). Classifier 80 may examine the tag of a packet to determine this classification in the event the packet has been previously classified (e.g., by the access control list or link scheduler modules). If the packet has not been previously classified, classifier 80 examines the packet to determine the classification as time-critical or time insensitive and provides the packet with a tag indicating the packet classification as described above. Packets are classified as time-critical (e.g., voice, etc.) when a time-critical packet originates or is created by the access router, or when a packet corresponds to return traffic sent in response to the router originated time-critical packets and terminates at the access router as described above. These conditions may be determined based on information within the packet (e.g., packet header, etc.). Packets may further be classified as time-critical based on user-configurable criteria as described above.

Bandwidth meter 82 measures the amount of time-critical traffic being prioritized in upstream processing. The bandwidth meter basically measures the quantity of packets, packet size and packet rate for the time-critical packets over a desired time interval. The time interval may be of any desired duration (e.g., milliseconds, seconds, etc.) sufficient to provide measurements for the parameters, while the meter typically measures the parameters continuously and/or periodically. The measured information is utilized to control the time insensitive traffic in the down-stream direction to maintain available bandwidth for time-critical packets as described below. Thus, the time-critical traffic is indirectly prioritized in the down-stream direction since the traffic cannot be directly controlled due to the queuing of packets in the edge router as described above.

Time-critical packets are stored in queue 84, while time insensitive packets are stored in queue 86. Upstream scheduler 88 prioritizes the time-critical packets for conveyance from the link scheduler to the voice processing module (e.g., and, hence, for transmission from the access router toward the backbone network). In particular, the upstream scheduler transmits or conveys packets within time-critical queue 84 to voice processing module 68 (FIG. 3) until queue 84 is depleted. When no time-critical packets reside in queue 84, time insensitive packets within queue 86 may be conveyed to voice processing module 68 for processing.

With respect to the down-stream direction (e.g., from the backbone network toward the end-user system), the link scheduler module receives a packet from the voice processing module as described above. Classifier 90 examines the packet to determine the packet classification as a time-critical or real-time packet (e.g., RT as viewed in FIG. 4) or as a time insensitive or non-real-time packet (e.g., NRT as viewed in FIG. 4) as described above. Classifier 90 is substantially similar to classifier 80 described above and may examine the tag of a packet to determine this classification in the event the packet has been previously classified (e.g., by the access control list or link scheduler modules). If the packet has not been previously classified, classifier 90 examines the packet to determine the classification as time-critical or time insensitive and provides the packet with a tag indicating the packet classification as described above. Packets are classified as time-critical (e.g., voice, etc.) when a time-critical packet originates or is created by the access router, or when a packet corresponds to return traffic sent in response to the router originated time-critical packets and terminates at the access router as described above. These conditions may be determined based on information within the packet (e.g., packet header, etc.). Packets may further be classified as time-critical based on user-configurable criteria as described above.

Time-critical packets are stored in queue 92. However, when queue 92 lacks sufficient storage capacity for the newly arriving packets, the packets are discarded. Accordingly, the size of queue 92 is preferably configured by the user to include a storage capacity or length sufficient to accommodate time-critical traffic bursts and minimize discarding of the time-critical packets.

Time insensitive packets are stored in queue 94. Packets arriving for storage in queue 94 are typically discarded in the event that queue 94 lacks sufficient storage capacity for the newly arriving packets. The size of queue 94 is preferably configured by the user and includes a storage capacity or length less than that of the queue utilized by the edge router. The maximum number of packets stored by queue 94 is configured to prevent the window size of time insensitive traffic from increasing significantly. A smaller size for queue 94 leads to an increased number of dropped time insensitive packets, whereas a greater size for queue 94 enables more frequent bursts of packets (e.g., time-critical and time insensitive) to fill the edge router queue, thereby causing delay for time-critical transfers.

Rate limiter 96 controls the amount of time insensitive packets retrieved from queue 94 for conveyance to down-stream scheduler 98. Rate limiter 96 and queue 94 basically form virtual bottleneck 52 (FIG. 2) to control the rate of transmission of time insensitive packets relative to that of time-critical packets. In particular, the rate limiter determines the down-stream bandwidth available for transmission of time insensitive packets after accounting for the bandwidth needed for time-critical traffic as measured by bandwidth meter 82. The amount of available bandwidth for transmission of time insensitive packets may be expressed as follows.
Available BW=Total BW−Measured BW−SF, (Equation 1)
where Available BW is the bandwidth available for transmission of time insensitive packets, Total BW is the total down-stream bandwidth which is preferably predetermined, Measured BW is the upstream bandwidth for time-critical or real-time packets measured by bandwidth meter 82 and SF is a safety margin or factor to maintain appropriate bandwidth availability for the time-critical packets. Thus, the rate limiter enables time-critical data to receive available bandwidth sufficient to accommodate that traffic, while remaining bandwidth is utilized for time insensitive packets.

The available bandwidth for time insensitive packets or the data rate for retrieval of those packets from the virtual bottleneck or queue 94 is selected to include the safety margin to enable traffic bursts of time insensitive packets to traverse the access line without causing annoying delays or packet losses in the edge router. The data rate or bandwidth is automatically lowered by the measured amount of time-critical traffic to maintain the safety margin at a sufficient level and to accommodate time insensitive traffic bursts. The efficiency of present invention may vary depending upon the amount of available bandwidth for the safety margin in the presence of time-critical traffic.

The packets within queues 92, 94 are conveyed to down-stream scheduler 98 for scheduling of transmission of the packets from the access router toward the end-user system. Rate limiter 96 controls the rate that time insensitive packets are conveyed to scheduler 98 in accordance with the determined bandwidth available for those packets (e.g., Equation 1). In particular, rate limiter 96 preferably employs a leaky bucket with an average bit rate and a burst tolerance measured as a number of packets to apply the bandwidth and burst limit to time insensitive traffic. Basically, the leaky bucket is represented by a packet counter that is incremented by an increment, preferably one, for each received time insensitive packet. The packet counter is decremented by a decrement, preferably one, at certain time intervals. When a time insensitive packet is received, the packet counter is incremented and the count value of the packet counter is compared to a threshold. If the count is less than the threshold, a time insensitive packet is conveyed from queue 94 to scheduler 98. When the count exceeds the threshold (e.g., upon receipt of a time insensitive packet), conveyance of a time insensitive packet from queue 94 waits for the count of the packet counter to be decremented in accordance with the decrement rate and fall below the threshold. Rate limiter 96 receives the measured information from bandwidth meter 82 and adjusts the parameters (e.g., decrement rate, packet counter range, increments, decrements, threshold, etc.) of the leaky bucket to convey time insensitive packets to scheduler 98 in accordance with the available bandwidth determined for the time insensitive packets as described above (e.g., Equation 1).

Time-critical packets are conveyed from queue 92 to down-stream scheduler 98 at a rate in accordance with the available bandwidth for transmissions from the access router. Since rate limiter 96 limits the conveyance of time insensitive traffic from queue 94, down-stream scheduler 98 receives time-critical packets from queue 92 at a rate in accordance with the remaining available bandwidth (e.g., the measured bandwidth of the time-critical traffic and the safety margin). Thus, the rate limiter restricts time insensitive traffic within queue 94 to ensure that sufficient bandwidth is available to accommodate the time-critical traffic within queue 92, thereby minimizing or eliminating transmission delays for the time-critical packets. When no time-critical packets reside in queue 92, time insensitive packets within queue 94 may be conveyed to scheduler 98 without restriction by rate limiter 96.

It will be appreciated that the embodiments described above and illustrated in the drawings represent only a few of the many ways of implementing a communication device and method of prioritizing transference of time-critical data.

The end-user and server computer systems may be of any quantity and may be implemented by any quantity of any personal or other type of computer or processing system (e.g., IBM-compatible, Apple, Macintosh, laptop, palm pilot, microprocessor, etc.). The end-user and server computer systems may include any conventional or other communications devices to communicate over a network. The computer systems may include any commercially available operating system (e.g., Windows, OS/2, Unix, Linux, etc.), any commercially available and/or custom software (e.g., communications software, server software, etc.) and any types of input devices (e.g., keyboard, mouse, microphone, voice recognition, etc.). The voice terminals may be of any quantity and may be implemented by any quantity of any conventional or other voice devices (e.g., voice terminals or handsets, telephones, computer or other processing systems with voice capability, etc.). The edge router may be of any quantity and may be implemented by any conventional or other routing devices (e.g., router, gateway, bridge, etc.) to interface a network.

The local network may include any quantity of nodes (e.g., computer or other processing systems, communication devices (e.g., router, gateway, voice or other terminals, etc.), etc.), may be implemented by any communications network (e.g., LAN, Intranet, etc.) and may utilize any conventional or other protocols (e.g., Ethernet, Point to Point Protocol Over Ethernet (PPPoE), Frame Relay, etc.). The backbone network may be implemented by any communications network with any communication protocols (e.g., LAN, WAN, Intranet, Internet, Fibre, SDH, ATM, TCP, UDP, etc.). The access line may be of any quantity and may be implemented by any conventional or other communication line with any data rate or bandwidth. The access line may accommodate any quantity of access, edge or other routing devices.

The access router processor may be implemented by any conventional or other controller or microprocessor. Alternatively, the processor may be implemented by any combination of processing devices, hardware modules and/or circuitry. The access router may accommodate any quantity of access lines and may be disposed at any location along those lines. The access router may be coupled to any quantity of any types of devices for transference of information (e.g., computer or processing systems, communication devices, voice devices, video devices, devices providing time-critical traffic, etc.). The access router may further include capabilities to perform functions of various other devices (e.g., edge router, gateway or bridge, modem, etc.). The access router may prioritize any type of time-critical or other data (e.g., voice, video, text messages with high priority, emergency messages, Web pages, chat room data, etc.). The time-critical or other packets may be identified with any type of identifier (e.g., tag, etc.). The identifier may reside in any field or location within the packet (e.g., header, etc.). The identifier may include any quantity of any alphanumeric characters or symbols (e.g., any quantity of bits, a code, a flag, etc.). Packets may be identified or marked for special processing based on any suitable user-defined or predetermined criteria (e.g., processed by the access router, originated from or intended for a particular site or device, user-defined rules, etc.).

The access router may include any quantity of any conventional or other microprocessors, controllers, processing systems and/or circuitry. The various access router modules (e.g., link scheduler, voice processing, network translation, access control list, encryption/decryption, etc.) may be implemented by hardware modules (e.g., circuitry, processors, etc.), software modules or any combination thereof. The various functions of the access router modules (e.g., address translation, virtual bottleneck, voice processing, classifying and/or marking packets, filtering, encryption/decryption, etc.) may be distributed among any quantity of access router or other modules in any fashion. The encryption/decryption module may employ any conventional or other techniques to perform any desired type of encryption and/or decryption. The network translation module may employ any conventional or other techniques to translate addresses between networks. The voice processing module may employ any conventional or other techniques to perform various voice processing functions (e.g., A/D or D/A conversion, conversion between data formats, etc.). The access control list module may employ any conventional or other techniques to perform packet classification and/or filtering (e.g., based on any suitable criteria or data fields, etc.). The packet classification may be performed by the link scheduler module alone or in combination with the access control list module, and in either or both of the upstream and down-stream directions by the modules in any desired combination (e.g., one module classifies packets in the upstream direction and one module classifies packets in the down-stream direction, etc.).

The various elements of the link scheduler module (e.g., classifiers, queues, rate limiter, scheduler, meter, etc.) may be implemented by hardware modules (e.g., circuitry, processors, etc.), software modules or any combination thereof. The various functions of the link scheduler module (e.g., classifiers, queues, rate limiter, scheduler, meter, etc.) may be distributed among any quantity of link scheduler or other modules in any fashion. The classifiers may employ any conventional or other technique to classify and/or mark packets (e.g., examine particular fields, examine the type of data within the packet, utilize any portion of the packet to provide a type indicator, etc.). The queues may be of any quantity, may be implemented by any types of data structures (e.g., queue, array, linked list, etc.), may be of any size and may store any types of data. The queues may utilize any conventional or other techniques for data storage and retrieval (e.g., random access, FIFO, LIFO, etc.). The queues may alternatively be implemented by an integral queue storing all packet types, where the queue can identify and retrieve particular packets. The schedulers may employ any conventional or other techniques to retrieve packets from the queues and schedule packets for transmission (e.g., retrieve and transmit time-critical packets first, alternate between queues for retrieval and transmission, utilize time intervals for retrieval and transmission, transmission rate based on bandwidth or other conditions, etc.).

The meter may measure any desired parameters (e.g., packet quantity, packet size, packet length, bandwidth, etc.) for any desired time intervals (e.g., milliseconds, seconds, etc.) and may provide measurements in any desired quantities or units (e.g., bits per second, packets per second, total bits, total packets, average packet size, etc.). The meter may provide measurements to any desired elements (e.g., queues, schedulers, classifiers, etc.) to enable those elements to control traffic flow. The rate limiter may employ any conventional or other techniques to limit transmission of time insensitive or other non-priority packets (e.g., leaky bucket, utilize time intervals for transmission, transmission based on bandwidth or other conditions, etc.). A rate limiter may be further applied to the queue for time-critical or priority packets to regulate traffic flow. The increment and decrement values may be any desired values and may be applied to the counter based on any time intervals or desired events or conditions (e.g., arrival of a packet, transmission of a packet, etc.). The threshold may be set to any desired value to control traffic flow. The rate limiter may adjust any leaky bucket parameters (e.g., increment, decrement, decrement rate, threshold, etc.) to accommodate traffic flow of time-critical or priority packets. The packet counter may be implemented by any suitable software and/or hardware modules (e.g., software counter, hardware counter, etc.).

The virtual bottleneck of the present invention may be applied in the upstream and/or downstream directions to prioritize traffic and may be implemented within other devices within the access configuration (e.g., LAN, edge router, etc.).

It is to be understood that the software of the present invention may be implemented in any desired computer language, and could be developed by one of ordinary skill in the computer and/or programming arts based on the functional description contained herein and the diagrams illustrated in the drawings. Further, any references herein of software performing various functions generally refer to computer systems or processors performing those functions under software control. The various functions of the access router may be distributed in any manner among any quantity (e.g., one or more) of hardware and/or software modules or units, computer or processing systems or circuitry, where the computer or processing systems may be disposed locally or remotely of each other and communicate via any suitable communications medium (e.g., LAN, WAN, Intranet, Internet, hardwire, modem connection, wireless, etc.). The software and/or algorithms described above and illustrated in the diagrams may be modified in any manner that accomplishes the functions described herein.

The present invention may be available in the form of an access or other routing device, where the routing device may be implemented by a computer or other processing system or circuitry to perform the functions described above. The present invention may alternatively be available in the form of hardware and/or software modules (e.g., routing card, etc.) for use on routing devices (e.g., router, gateway, processing system to be used for routing functions, etc.), or may be in the form of embeddable hardware and/or software modules (e.g., within another system, as an embeddable software component within other software, etc.). The present invention software may be available on a recordable medium (e.g., magnetic or optical mediums, magneto-optic mediums, floppy diskettes, CD-ROM, DVD, memory devices, cards, etc.), and/or may be downloaded (e.g., in the form of carrier waves, packets, etc.) to systems or devices via a network or other communications medium.

The present invention is not limited to the applications described herein, but may be utilized for any types of data transfers or networks with a flow control scheme autonomously detecting available bandwidth based on congestion indicators in the form of delay and discarded packets. The present invention may accommodate packets or data of any desired size, length or type and including any desired information, where the packets or data may be arranged in any desired format.

From the foregoing description, it will be appreciated that the invention makes available a novel communication device and method of prioritizing transference of time-critical data, wherein a virtual bottleneck employed by a communication device delays and/or discards time insensitive packets based on the bandwidth required for time-critical packets (e.g., voice calls, etc.) in order to ensure that sufficient bandwidth is available for transference of the time-critical packets.

Having described preferred embodiments of a new and improved communication device and method of prioritizing transference of time-critical data, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A communication device disposed between an end-user unit and a network to prioritize transfer of data comprising:
a processor to process said data and prioritize transfer of data of a designated type relative to other data, wherein said processor includes:
a measurement module to measure a flow rate of said designated data through said communication device; and
a priority module to control a flow rate of said other data through said communication device in accordance with said measured flow rate of said designated data to prioritize transfer of said designated data relative to said other data.

2. The device of claim 1, wherein said processor further includes:
a classification module to determine a type of said data and to associate said data with an identifier in response to determining said data is of said designated type.

3. The device of claim 1, wherein said measurement module measures said flow rate of said designated data in a first direction of data flow through said communication device and toward said network, and said priority module includes:
a flow control module to control said flow rate of said other data through said communication device in a second direction of data flow toward said end-user unit based on said flow rate of said designated data measured by said measurement module in said first data flow direction.

4. The device of claim 3, wherein said flow control module includes:
a first data storage unit to store data of said designated type received by said communication device and flowing in said second data flow direction;
a second data storage unit to store data of a type other than said designated type received by said communication device and flowing in said second data flow direction; and
a rate module to control conveyance of said other data from said second data storage unit in accordance with said flow rate of said designated data measured by said measurement module.

5. The device of claim 4, wherein said rate module includes:
a bandwidth module to determine available bandwidth for conveyance of said other data based on a predetermined total bandwidth for said communication device, said measured flow rate of said designated data and a predetermined portion of said total bandwidth to serve as a safety margin to accommodate bursts of data traffic; and
a rate control module to control conveyance of said other data from said second storage unit in accordance with said available bandwidth.

6. The device of claim 4, wherein said processor further includes:
a first classification module to determine a type of said data received by said communication device and flowing in said first direction;
a first storage unit to store data of said designated type received by said communication device and flowing in said first direction;
a second storage unit to store data of a type other than said designated type received by said communication device and flowing in said first direction;
a first scheduler module to facilitate transmission of data from said first and second storage units toward said network;
a second classification module to determine a type of said data received by said communication device and flowing in said second direction; and
a second scheduler module to facilitate transmission of data from said first and second data storage units toward said end-user unit.

7. The device of claim 6, wherein said first and second classification modules each include:
an identifier module to associate said data with an identifier in response to determining said data is of said designated type in accordance with predetermined criteria.

8. The device of claim 7, wherein said predetermined criteria are defined by a user.

9. The device of claim 1, wherein said designated data is time-critical data.

10. The device of claim 9, wherein said designated data includes at least one of audio and video data.

11. The device of claim 1, wherein said device is coupled to at least one of said end-user unit and a local network and interfaces an access line of said network.

12. The device of claim 1, wherein said end-user unit includes at least one of a computer system and a voice communication device.

13. A program product apparatus including a computer readable medium with computer program logic recorded thereon for prioritizing transfer of data of a designated type relative to other data within a communication device disposed between an end-user unit and a network, said program product apparatus comprising:
a measurement module to measure a flow rate of said designated data through said communication device; and
a priority module to control a flow rate of said other data through said communication device in accordance with said measured flow rate of said designated data to prioritize transfer of said designated data relative to said other data.

14. The apparatus of claim 13 further including:
a classification module to determine a type of said data and to associate said data with an identifier in response to determining said data is of said designated type.

15. The apparatus of claim 13, wherein said measurement module measures said flow rate of said designated data in a first direction of data flow through said communication device and toward said network, and said priority module includes:
a flow control module to control said flow rate of said other data through said communication device in a second direction of data flow toward said end-user unit based on said flow rate of said designated data measured by said measurement module in said first data flow direction.

16. The apparatus of claim 15, wherein said flow control module includes:
a first data storage unit to store data of said designated type received by said communication device and flowing in said second data flow direction;
a second data storage unit to store data of a type other than said designated type received by said communication device and flowing in said second data flow direction; and
a rate module to control conveyance of said other data from said second data storage unit in accordance with said flow rate of said designated data measured by said measurement module.

17. The apparatus of claim 16, wherein said rate module includes:
a bandwidth module to determine available bandwidth for conveyance of said other data based on a predetermined total bandwidth for said communication device, said measured flow rate of said designated data and a predetermined portion of said total bandwidth to serve as a safety margin to accommodate bursts of data traffic; and
a rate control module to control conveyance of said other data from said second storage unit in accordance with said available bandwidth.

18. The apparatus of claim 16 further including:
a first classification module to determine a type of said data received by said communication device and flowing in said first direction;
a first storage unit to store data of said designated type received by said communication device and flowing in said first direction;
a second storage unit to store data of a type other than said designated type received by said communication device and flowing in said first direction;
a first scheduler module to facilitate transmission of data from said first and second storage units toward said network;
a second classification module to determine a type of said data received by said communication device and flowing in said second direction; and
a second scheduler module to facilitate transmission of data from said first and second data storage units toward said end-user unit.

19. The apparatus of claim 18, wherein said first and second classification modules each include:
an identifier module to associate said data with an identifier in response to determining said data is of said designated type in accordance with predetermined criteria.

20. The apparatus of claim 13, wherein said designated data is time-critical data.

21. A carrier signal including computer program logic embedded therein for prioritizing transfer of data of a designated type relative to other data within a communication device disposed between an end-user unit and a network, said carrier signal comprising:
a measurement module to measure a flow rate of said designated data through said communication device; and
a priority module to control a flow rate of said other data through said communication device in accordance with said measured flow rate of said designated data to prioritize transfer of said designated data relative to said other data.

22. The carrier signal of claim 21 further including:
a classification module to determine a type of said data and to associate said data with an identifier in response to determining said data is of said designated type.

23. The carrier signal of claim 21, wherein said measurement module measures said flow rate of said designated data in a first direction of data flow through said communication device and toward said network, and said priority module includes:
a flow control module to control said flow rate of said other data through said communication device in a second direction of data flow toward said end-user unit based on said flow rate of said designated data measured by said measurement module in said first data flow direction.

24. The carrier signal of claim 23, wherein said flow control module includes:
a first data storage unit to store data of said designated type received by said communication device and flowing in said second data flow direction;
a second data storage unit to store data of a type other than said designated type received by said communication device and flowing in said second data flow direction; and
a rate module to control conveyance of said other data from said second data storage unit in accordance with said flow rate of said designated data measured by said measurement module.

25. The carrier signal of claim 24, wherein said rate module includes:
a bandwidth module to determine available bandwidth for conveyance of said other data based on a predetermined total bandwidth for said communication device, said measured flow rate of said designated data and a predetermined portion of said total bandwidth to serve as a safety margin to accommodate bursts of data traffic; and
a rate control module to control conveyance of said other data from said second storage unit in accordance with said available bandwidth.

26. The carrier signal of claim 24 further including:
a first classification module to determine a type of said data received by said communication device and flowing in said first direction;
a first storage unit to store data of said designated type received by said communication device and flowing in said first direction;
a second storage unit to store data of a type other than said designated type received by said communication device and flowing in said first direction;
a first scheduler module to facilitate transmission of data from said first and second storage units toward said network;
a second classification module to determine a type of said data received by said communication device and flowing in said second direction; and
a second scheduler module to facilitate transmission of data from said first and second data storage units toward said end-user unit.

27. The carrier signal of claim 26, wherein said first and second classification modules each include:
an identifier module to associate said data with an identifier in response to determining said data is of said designated type in accordance with predetermined criteria.

28. The carrier signal of claim 21, wherein said designated data is time-critical data.

29. A method of prioritizing transfer of data of a designated type relative to other data within a communication device disposed between an end-user unit and a network comprising:
(a) measuring a flow rate of said designated data through said communication device; and
(b) controlling a flow rate of said other data through said communication device in accordance with said measured flow rate of said designated data to prioritize transfer of said designated data relative to said other data.

30. The method of claim 29, wherein step (a) further includes:
(a.1) determining a type of said data and associating said data with an identifier in response to determining said data is of said designated type.

31. The method of claim 29, wherein step (a) further includes:
(a.1) measuring said flow rate of said designated data in a first direction of data flow through said communication device and toward said network; and
step (b) further includes:
(b.1) controlling said flow rate of said other data through said communication device in a second direction of data flow toward said end-user unit based on said measured flow rate of said designated data in said first data flow direction.

32. The method of claim 31, wherein step (b.1) further includes:
(b.1.1) storing data of said designated type received by said communication device and flowing in said second data flow direction within a first data storage unit;
(b.1.2) storing data of a type other than said designated type received by said communication device and flowing in said second data flow direction within a second data storage unit; and
(b.1.3) controlling conveyance of said other data from said second data storage unit in accordance with said measured flow rate of said designated data.

33. The method of claim 32, wherein step (b.1.3) further includes:
(b.1.3.1) determining available bandwidth for conveyance of said other data based on a predetermined total bandwidth for said communication device, said measured flow rate of said designated data and a predetermined portion of said total bandwidth to serve as a safety margin to accommodate bursts of data traffic; and
(b.1.3.2) controlling conveyance of said other data from said second data storage unit in accordance with said available bandwidth.

34. The method of claim 32, wherein step (a.1) further includes:
(a.1.1) determining a type of said data received by said communication device and flowing in said first direction;
(a.1.2) storing data of said designated type received by said communication device and flowing in said first direction within a first storage unit;
(a.1.3) storing data of a type other than said designated type received by said communication device and flowing in said first direction within a second storage unit; and
(a.1.4) facilitating transmission of data from said first and second storage units toward said network;
step (b.1.1) further includes:
(b.1.1.1) determining a type of said data received by said communication device and flowing in said second direction; and
step (b) further includes:
(b.1.4) facilitating transmission of data from said first and second data storage units toward said end-user unit.

35. The method of claim 34, wherein step (a.1.1) further includes:
(a.1.1.1) associating said data with an identifier in response to determining said data is of said designated type in accordance with predetermined criteria; and
step (b.1.1.1) further includes:
(b.1.1.1.1) associating said data with an identifier in response to determining said data is of said designated type in accordance with predetermined criteria.

36. The method of claim 35, wherein said predetermined criteria are defined by a user.

37. The method of claim 29, wherein said designated data is time-critical data.

38. The method of claim 37, wherein said designated data includes at least one of audio and video data.

39. The method of claim 29, wherein said communication device is coupled to at least one of said end-user unit and a local network and interfaces an access line of said network.

40. The method of claim 29, wherein said end-user unit includes at least one of a computer system and a voice communication device.
